(19) United States
(12) Patent Application Publication
(10) Pub. No.: US 2026/0024769 A1
(43) Pub. Date: Jan. 22, 2026

(54) COVALENT TRIAZINE FRAMEWORK POLYMER NANOSHEETS FOR CATHODE MATERIALS IN LITHIUM-SULFUR BATTERIES

(71) Applicant: Anhui University, Hefei (CN)

(72) Inventors: Shudong JIANG, Hefei (CN); Wenjie HU, Hefei (CN); Zhengzhi ZHENG, Hefei (CN); Suyi LI, Hefei (CN)

(73) Assignee: Anhui University, Hefei (CN)

(21) Appl. No.: 19/340,838

(22) Filed: Sep. 25, 2025

(30) Foreign Application Priority Data
Jan. 15, 2025 (CN) 202510062269.0

(51) Int. Cl. H01M 4/62; C08G 73/08; H01M 4/38; H01M 10/052; H01M 10/42

(52) U.S. Cl. CPC H01M 4/62; C08G 73/08; H01M 4/38; H01M 10/052; H01M 10/4235

(57) ABSTRACT

The present disclosure belongs to the technical field of lithium-sulfur batteries, and discloses covalent triazine framework polymer nanosheets for cathode materials in lithium-sulfur batteries. The hexaazatriphenylenehexacarbonitrile monomer on the surface of sodium chloride is polymerized through high temperature triazine, sodium chloride crystal is removed to obtain covalent triazine framework polymer nanosheets product, and cathode materials in lithium-sulfur batteries are obtained after melting sulfur. The preparation method of the present disclosure is simple, has low cost, high yield, and uniform structure. The obtained material itself has a porous structure and numerous active sites. When used in lithium-sulfur batteries, it can promote the rapid conversion of lithium polysulfides, effectively suppress the shuttle effect, and improve the rate performance and cycle performance of lithium-sulfur batteries.

### TECHNICAL FIELD

The present disclosure belongs to the technical field of lithium-sulfur batteries, and relates to covalent triazine framework polymer nanosheets for cathode materials in lithium-sulfur batteries.

### BACKGROUND

With the continuous development and progress of modern society, the development and utilization of clean energy has become a key direction in relevant fields. Through explorations by numerous researchers, many green and environmentally friendly new energy sources have been discovered, such as solar energy, wind energy, and hydrogen energy. Nevertheless, these clean energy sources have specific environmental requirements in practical applications and may also cause an imbalance between power supply and demand, significantly hindering their practical utilization. Consequently, it is necessary to develop a novel energy storage device to effectively convert, store, and utilize the clean energy sources. In recent years, lithium-sulfur (Li—S) batteries have been regarded as one of the most promising energy storage systems due to their high theoretical capacity (1675 mAh/g), high energy density (2600 Wh/kg), and environmental friendliness. Moreover, elemental sulfur offers advantages such as low cost, non-pollution, and abundant reserves on Earth.

Despite these advantages, the practical application of Li—S batteries is still constrained by several issues, such as the shuttle effect of lithium polysulfide intermediates and the poor conductivity of sulfur. To address the above issues, various materials with high specific surface areas and excellent conductivity have been employed as sulfur carriers, including graphene, carbon spheres, carbon nanotubes (CNTs), metal-organic frameworks, and covalent organic frameworks. However, the weak adsorption capacity of these materials toward lithium polysulfides is insufficient to mitigate sulfur loss in Li—S batteries.

In view of the foregoing, there is a need to develop a simple and efficient preparation method to synthesize materials with unique structures, ensuring high yield and superior performance to satisfy their application as cathode materials in Li—S batteries.

### SUMMARY

In view of the above technical problems, the present disclosure provides covalent triazine framework polymer nanosheets for cathode materials in lithium-sulfur batteries, aiming to achieve the rapid conversion of lithium polysulfides and the efficient suppression of the shuttle effect, and improve the energy density and charge-discharge cycle performance of the cathode of lithium-sulfur batteries.

In order to solve the technical problems, the present disclosure adopts the following technical solution:

A preparation method for covalent triazine framework polymer nanosheets for cathode materials in lithium-sulfur batteries is provided, and the method includes the following steps:
step 1: adding cyclohexanehexone and diaminomaleonitrile into acetic acid, heating under reflux for reaction; after the reaction, washing with hot acetic acid to obtain a crude product containing hexaazatriphenylenehexacarbonitrile (HATCN); ultrasonically dispersing the crude product in nitric acid solution, and continuing heating under reflux for reaction; after the reaction, adding ice water for refrigerating and standing; obtaining a primarily purified HATCN by washing the obtained product with deionized water and vacuum drying;
step 2: ultrasonically dissolving the primarily purified HATCN in an acetonitrile solution, heating under reflux for reaction; after the reaction, obtaining a secondarily purified HATCN by washing with acetonitrile and vacuum drying;
step 3: adding the secondarily purified HATCN into acetonitrile and magnetically stirring until dissolved, then adding sodium chloride and stirring with a paddle until uniformly dispersed; drying the obtained mixture to fully evaporate acetonitrile, thereby obtaining a solid mixture of HATCN and sodium chloride;
step 4: in a liquid nitrogen cryogenic environment, adding trifluoromethanesulfonic acid into a glass tube, then adding the solid mixture obtained in step 3, vacuumizing the system and flame-sealing; transferring the system to a tube furnace and calcining under an inert atmosphere to enable triazine polymerization of HATCN on the surface of sodium chloride crystals, thereby obtaining covalent triazine framework-hexaazatriphenylenehexacarbonitrile (CTF-HATCN);
step 5: removing sodium chloride particles, collecting the product and freeze-drying, then ultrasonically dispersing and exfoliating the CTF-HATCN to obtain CTF-HATCN nanosheets for cathode materials in lithium-sulfur batteries.

In some embodiments, in step 1, when preparing the crude product containing HATCN, a dosage ratio of cyclohexanehexone, diaminomaleonitrile and acetic acid is 0.4 g:1.1 g:15-20 mL, and a reaction temperature of the heating reflux reaction is 90-110° C. with a reaction time of 4-6 h.

In some embodiments, in step 1, a concentration of the nitric acid solution is 20-30%, a reaction temperature of the continuous heating reflux reaction is 90-110° C., and a reaction time is 2-4 h, a volume ratio of the nitric acid solution to ice water is 1:1-3, and a temperature for refrigerating and standing is 0-10° C. with a time of 12-24 h.

In some embodiments, a dosage ratio of the acetonitrile in step 2 to the cyclohexanehexone in step 1 is 350-450 mL:0.4 g, and a reaction temperature for the heating reflux reaction is 80-90° C. with a reaction time of 2-3 h.

In some embodiments, in step 3, a dosage ratio of the secondarily purified HATCN to the sodium chloride is 0.1 g:10-20 g, and a drying temperature is 60-80° C. with a drying time of 20-24 h.

In some embodiments, a dosage ratio of the trifluoromethanesulfonic acid in step 4 to the secondarily purified HATCN in step 3 is 20-30 μL:0.1 g, the inert atmosphere is argon or nitrogen, a calcination temperature is 400-600° C. with a holding time of 16-20 h.

In some embodiments, in step 5, the method for removing sodium chloride particles is to dissolve sodium chloride with ultrapure water and collect the product by vacuum filtration.

The covalent triazine framework polymer nanosheets prepared by the present disclosure can be used as cathode materials in lithium-sulfur batteries. An application method includes: mixing CTF-HATCN nanosheets with sublimed sulfur, grinding the mixture uniformly and loading into a reactor under a nitrogen atmosphere, and obtaining cathode active materials for lithium-sulfur batteries by heating.

In some embodiments, a dosage ratio of CTF-HATCN nanosheets to sublimed sulfur is 0.3 g:0.7-1 g, a heating reaction temperature is 150-160° C., with a reaction time of 8-10 h.

Compared with the prior art, the beneficial effects of the present disclosure are as follows:
1. The selected monomer HATCN in the present disclosure exhibits a high molecular weight and a stable structure. After polymerization, the resulted CTF-HATCN can form an ordered macroporous triazine framework with abundant pore structures and numerous reactive sites. Meanwhile, sodium chloride is introduced as a template, enabling the formation of uniform sheet structures after simple exfoliation. The uniform stacking of these sheets can effectively catalyze the conversion of lithium polysulfides, reduce the loss of active materials, and suppress the shuttle effect of polysulfides, ultimately improving the electrochemical performance of lithium-sulfur batteries.
2. When applied in lithium-sulfur batteries, the cathode materials in lithium-sulfur batteries prepared by the present disclosure demonstrate high discharge specific capacity and better cycling performance. The initial discharge specific capacity reaches 953.41 mAh/g at a 0.2 C rate, and the discharge specific capacity is 626.03 mAh/g after 200 cycles.

### BRIEF DESCRIPTION OF THE DRAWINGS

FIG. 1 shows Fourier-transform infrared absorption spectroscopy (FTIR) spectra of HATCN monomer obtained in step 2 and CTF-HATCN nanosheets obtained in step 5 of Example 1;

FIG. 2 shows a scanning electron microscopy (SEM) image of CTF-HATCN nanosheets obtained in Example 1;

FIG. 3 shows a transmission electron microscopy (TEM) image of CTF-HATCN nanosheets obtained in Example 1;

FIG. 4 shows an SEM image of a covalent triazine framework polymer obtained in Example 2;

FIG. 5 shows an atomic force microscopy (AFM) image (FIG. 5(a)) and corresponding thickness data (FIG. 5(b)) of CTF-HATCN nanosheets obtained in Example 1;

FIG. 6 shows a nitrogen adsorption-desorption curve of CTF-HATCN nanosheets obtained in Example 1;

FIG. 7 shows a pore size distribution of CTF-HATCN nanosheets obtained in Example 1;

FIG. 8 shows a cycling performance of a target product obtained in Example 1 when used as cathode materials in lithium-sulfur batteries;

FIG. 9 shows cyclic voltammetry curves of a target product obtained in Example 1 when used as cathode materials in lithium-sulfur batteries.

### DETAILED DESCRIPTION OF THE EMBODIMENTS

The following provides a detailed description of the examples of the present disclosure. The examples described below are implemented based on the technical solutions of the present disclosure, with detailed embodiments and specific operational processes provided. However, the scope of protection of the present disclosure is not limited to the examples described below. Unless otherwise specified, the experimental methods used in the following examples are conventional methods; unless otherwise specified, the reagents, materials, etc. used in the following examples can be obtained commercially; the battery performance tests in the following examples are all performed using the LAND testing system.

The centrifuge used in the following examples is the Anke TGL-10B produced by Shanghai Anting Scientific Instrument Factory, the magnetic stirrer is the RT-10 multi-point magnetic stirrer produced by Guangzhou Yike Laboratory Technology Co., Ltd., the calcination furnace is the OTF-1200X produced by Hefei Kejing Materials Technology Co., Ltd., the scanning electron microscope is the Zeiss Supra 40 produced in Germany, and the transmission electron microscope is the JEOL-F2010 produced in Japan. The chemicals used in the following examples are purchased and used directly without any further processing.

### Example 1

In this example, covalent triazine framework polymer nanosheets are prepared according to the following steps:

Step 1: 0.4 g of cyclohexanehexone, and 1.1 g of diaminomaleonitrile are added to 15 mL of acetic acid, followed by heating under reflux at 100° C. for 4 h. After the reaction, the crude product containing HATCN is obtained by washing with hot acetic acid at 80° C. several times. The crude product is then ultrasonically dispersed in 20 mL of 30% nitric acid solution, and heating under reflux is continued at 100° C. for 2 h. After the reaction, 40 mL of ice water is added, and the product is placed in the refrigerator at 0° C. for 12 h. The resulted product is washed with deionized water and vacuum-dried to obtain the primarily purified HATCN.

Step 2: the primarily purified HATCN is ultrasonically dissolved in 400 mL of acetonitrile solution, followed by heating under reflux at 80° C. for 2 h. After the reaction, the secondarily purified HATCN is obtained by washing with acetonitrile and vacuum-drying.

Step 3:0.1 g of the secondarily purified HATCN is added into 15 mL of acetonitrile and magnetically stirred until dissolved. Then 20 g of sodium chloride is added and stirred with a paddle until uniformly dispersed; the mixture is dried in an oven at 80° C. for 24 h to fully evaporate the acetonitrile, thereby obtaining the solid mixture of HATCN and sodium chloride.

Step 4: in a liquid nitrogen cryogenic environment, 20 μL of trifluoromethanesulfonic acid is first added to the glass tube, followed by the addition of the solid mixture obtained in step 3. The system is then vacuumized and flame-sealed, and transferred to a tube furnace, where it is calcined at 400° C. for 20 h under an argon atmosphere to enable triazine polymerization of HATCN on the surface of sodium chloride crystals, thereby obtaining CTF-HATCN.

Step 5: ultrapure water is used to dissolve sodium chloride, and the product is collected through vacuum filtration. After freeze-drying, the obtained CTF-HATCN is ultrasonically dispersed and exfoliated to yield CTF-HATCN nanosheets as cathode materials for lithium-sulfur batteries.

### Example 2

In this example, covalent triazine framework polymer nanosheets are prepared according to the following steps:

Step 1: 0.4 g of cyclohexanehexone and 1.1 g of diaminomaleonitrile are added to 15 mL of acetic acid, followed by heating under reflux at 100° C. for 4 h. After the reaction, the crude product containing HATCN is obtained by washing with hot acetic acid at 80° C. several times. The crude product is then ultrasonically dispersed in 20 mL of 30% nitric acid solution, followed by heating under reflux at 100° C. for 2 h. After the reaction, 40 mL of ice water is added, and the product is placed in the refrigerator at 0° C. for 12 h. The resulted product is washed with deionized water and vacuum-dried to obtain the primarily purified HATCN.

Step 2: the primarily purified HATCN is ultrasonically dissolved in 400 mL of acetonitrile solution, followed by heating under reflux at 80° C. for 2 h. After the reaction, the secondarily purified HATCN is obtained by washing with acetonitrile and vacuum-drying.

Step 3: in a liquid nitrogen cryogenic environment, 0.1 g of HATCN obtained in step 2 is added to the glass tube. The system is then vacuumized, flame-sealed, and transferred to a tube furnace, where it is calcined at 400° C. for 20 h under an argon atmosphere to enable triazine polymerization of HATCN, thereby obtaining CTF-HATCN.

Step 4: the obtained CTF-HATCN is ultrasonically dispersed and exfoliated.

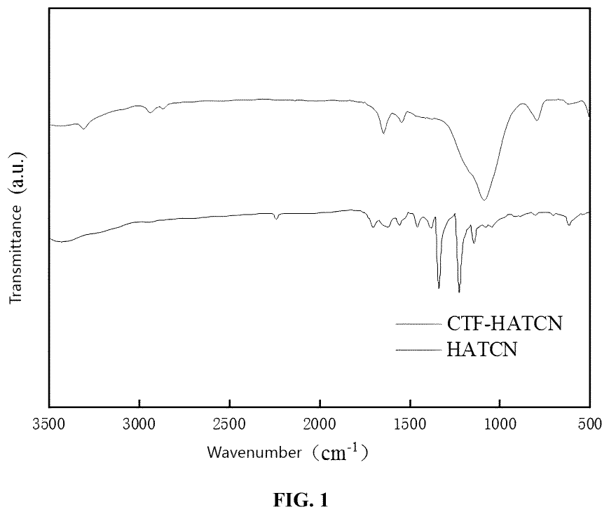

FIG. 1 shows FTIR spectra of the HATCN monomer and the CTF-HATCN nanosheets of Example 1, which indicates that the monomer has completed triazine polymerization to form a covalent triazine framework polymer with a very high degree of polymerization.

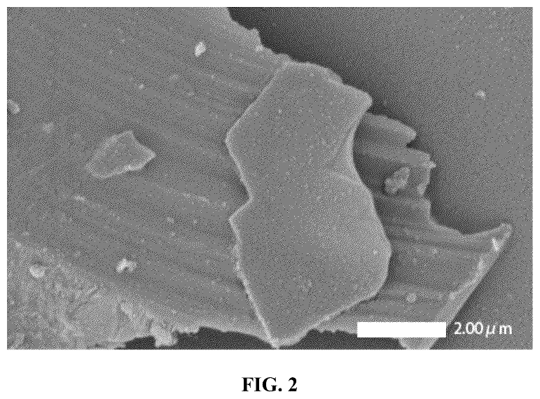

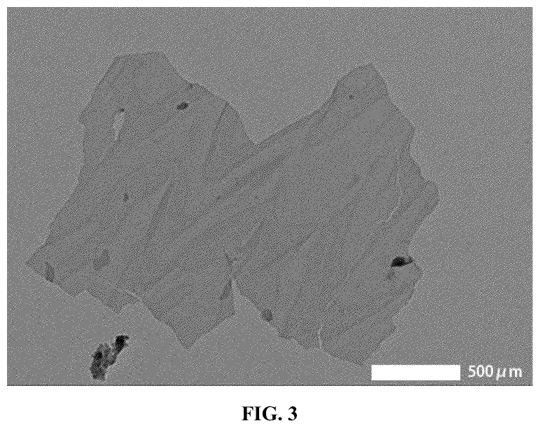

FIG. 2 and FIG. 3 are the SEM image and TEM image of the CTF-HATCN nanosheets obtained in step 5 of Example 1, respectively. It can be seen that CTF-HATCN exhibits a nanosheet structure with a lateral size of approximately 1 μm.

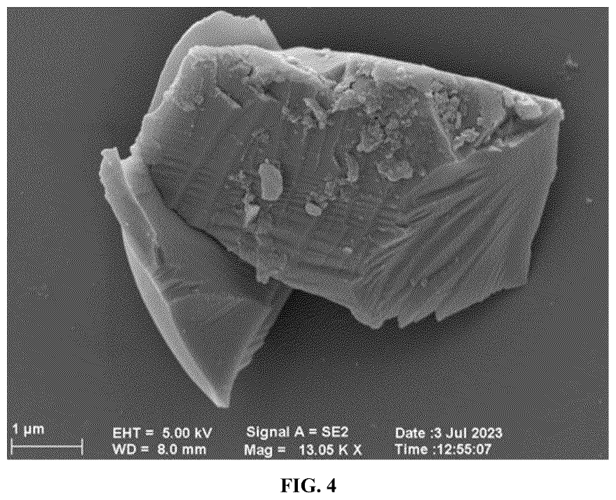

FIG. 4 is the SEM image of the sample that is obtained after ultrasonic exfoliation in step 4 of Example 2. It can be seen that the polymer exhibits a distinct bulk structure without NaCl as a template.

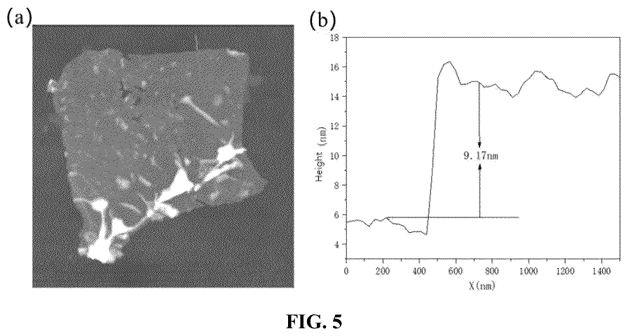

FIG. 5 is the AFM image (FIG. 5(a)) and corresponding thickness data (FIG. 5(b)) of the CTF-HATCN nanosheets obtained in step 5 of Example 1. It can be seen that the thickness of the single layer is approximately 10 nm.

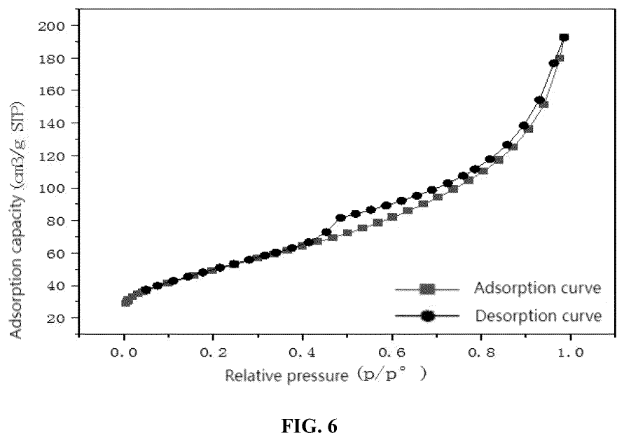

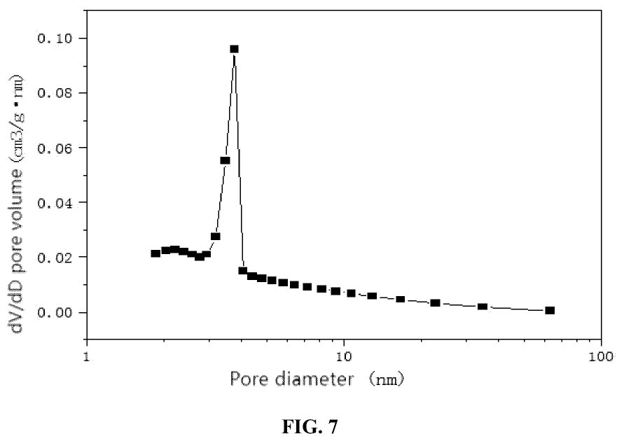

FIG. 6 and FIG. 7 are the nitrogen adsorption-desorption curve and pore size distribution of the CTF-HATCN nanosheets obtained in step 5 of Example 1. It can be seen that the specific surface area of the obtained polymer nanosheets is about 200 cm³/g, and the pore size is about 2-3 nm.

The sublimated sulfur and the CTF-HATCN nanosheets obtained in Example 1 are mixed according to a mass ratio of 7:3. The mixture is then ground uniformly and loaded into a reactor to place in a nitrogen atmosphere, and reacted at 155° C. for 8 h to obtain cathode active materials for lithium-sulfur batteries. After the obtained black active material is ground, it is mixed with the conductive agent SuperP and the binder polyvinylidene fluoride (PVDF) according to the mass ratio of 7:2:1.1-Methyl-2-pyrrolidinone (NMP) is then added, and the mixture is thoroughly stirred to form a homogeneous slurry. This slurry is subsequently coated uniformly on the surface of one side of the aluminum foil. It is dried under vacuum at 55° C. for 12 h, and cut into raw electrode sheets with a diameter of 12 mm and a sulfur loading of approximately 1 mg/cm².

The electrode sheets are put into a glove box filled with argon gas, and assembled into a button battery according to the assembly sequence of negative shell, lithium sheet, diaphragm, electrolyte, cathode sheet, gasket, spring sheet and positive shell. The battery is sealed by the tabletting machine, and the battery is stood for 12 h to perform the cycle performance test on the LAND test system.

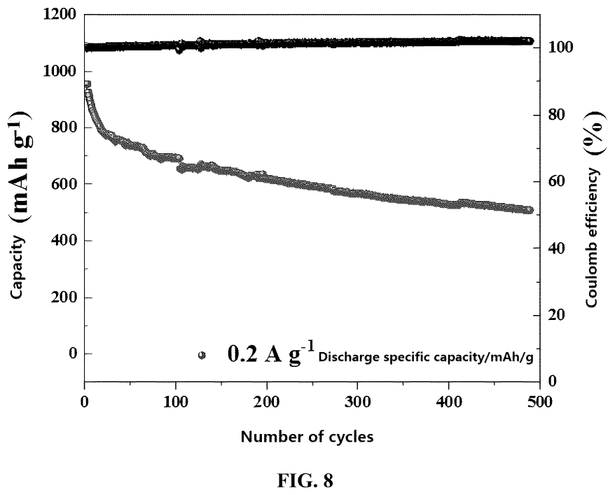

FIG. 8 shows the cycling performance of the target product obtained in Example 1 when used as a cathode material in lithium-sulfur batteries. It can be seen that at a current density of 0.2 A/g, the material exhibits an initial discharge specific capacity of 953 mAh/g and an initial Coulombic efficiency of 99.63% when used as the cathode in lithium-sulfur batteries. After 500 cycles, a reversible specific capacity of 517 mAh/g is retained, indicating that the material obtained in this example has good cycling performance as a cathode for lithium-sulfur batteries.

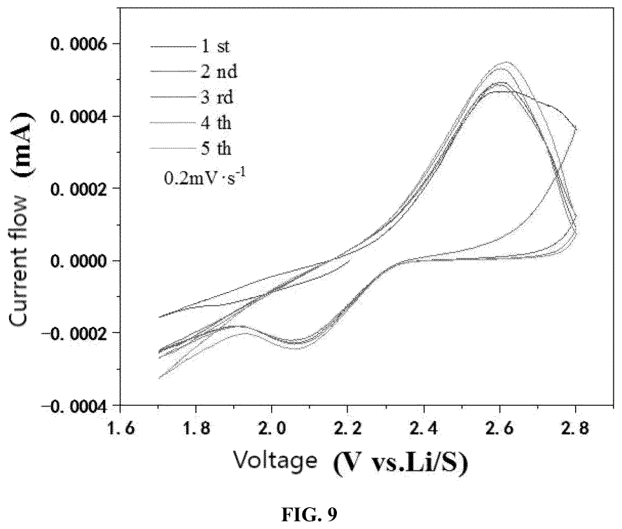

FIG. 9 shows the cyclic voltammetry curves of the target product obtained in Example 1 when used as a cathode material in lithium-sulfur batteries.

The above are merely exemplary examples of the present disclosure and are not intended to limit the scope of the present disclosure. Any modifications, equivalent substitutions, and improvements made within the spirit and principles of the present disclosure should be included within the scope of protection of the present disclosure.

What is claimed is:

1. A preparation method for covalent triazine framework polymer nanosheets for cathode materials in lithium-sulfur batteries, comprising the following steps:
step 1: adding cyclohexanehexone and diaminomaleonitrile into acetic acid;
heating under reflux for a first reaction;
after the reaction, washing with hot acetic acid to obtain a crude product containing hexaazatriphenylenehexacarbonitrile (HATCN);
ultrasonically dispersing the crude product in nitric acid solution, and continuing heating under reflux for a second reaction;
after the second reaction, adding ice water for refrigerating and standing;
obtaining a primarily purified HATCN by washing the obtained product with deionized water and vacuum drying;
step 2: ultrasonically dissolving the primarily purified HATCN in an acetonitrile solution, heating under reflux for a third reaction;
after the third reaction, obtaining a secondarily purified HATCN by washing with acetonitrile and vacuum drying;
step 3: adding the secondarily purified HATCN into acetonitrile and magnetically stirring until dissolved, then adding sodium chloride and stirring until obtaining a uniformly dispersed mixture;
drying the obtained uniformly dispersed mixture to fully evaporate acetonitrile, thereby obtaining a solid mixture of HATCN and sodium chloride;
step 4: in a liquid nitrogen cryogenic environment, adding trifluoromethanesulfonic acid into a glass tube, then adding the solid mixture obtained in step 3, vacuumizing the system and flame-sealing;
transferring the system to a tube furnace and calcining under an inert atmosphere to enable triazine polymerization of HATCN on the surface of sodium chloride crystals, thereby obtaining CTF-HATCN; wherein a dosage ratio of the trifluoromethanesulfonic acid to the secondarily purified HATCN in step 3 is 20-30 μL:0.1 g, the inert atmosphere is argon or nitrogen, and a calcination temperature is 400-600° C. with a holding time of 16-20 h; and
step 5: removing sodium chloride particles, collecting the product and freeze-drying, then ultrasonically dispersing and exfoliating the obtained CTF-HATCN to obtain covalent triazine framework polymer nanosheets for cathode materials in lithium-sulfur batteries, wherein the triazine framework polymer nanosheets are CTF-HATCN nanosheets.

2. The preparation method according to claim 1, wherein in step 1, when preparing the crude product containing HATCN, a dosage ratio of the cyclohexanehexone, diaminomaleonitrile and the acetic acid is 0.4 g:1.1 g:15-20 mL, and a reaction temperature of the heating reflux reaction is 90-110° C. with a reaction time of 4-6 h.

3. The preparation method according to claim 1, wherein in step 1, a concentration of the nitric acid solution is 20-30%, a reaction temperature of the continuous heating reflux reaction is 90-110° C., and a reaction time is 2-4 h, and wherein a volume ratio of the nitric acid solution to ice water is 1:1-3, and a temperature for refrigerating and standing is 0-10° C. with a time of 12-24 h.

4. The preparation method according to claim 1, wherein a dosage ratio of the acetonitrile in step 2 to the cyclohexanehexone in step 1 is 350-450 mL:0.4 g, and a reaction temperature for the heating reflux reaction is 80-90° C. with a reaction time of 2-3 h.

5. The preparation method according to claim 1, wherein in step 3, a dosage ratio of the secondarily purified HATCN to the sodium chloride is 0.1 g:10-20 g, and a drying temperature is 60-80° C., with a drying time of 20-24 h.

6. The preparation method according to claim 1, wherein in step 5, the method for removing sodium chloride particles is to dissolve sodium chloride with ultrapure water and collect the product by vacuum filtration.

7. The covalent triazine framework polymer nanosheets prepared by the preparation method according to claim 6.

8. An application for the covalent triazine framework polymer nanosheets according to claim 7 in cathode materials in lithium-sulfur batteries, wherein the CTF-HATCN nanosheets are mixed with sublimed sulfur, the mixture is ground uniformly and loaded into a reactor under a nitrogen atmosphere, and cathode active materials for lithium-sulfur batteries are obtained by heating.

9. The application according to claim 8, wherein a dosage ratio of the CTF-HATCN nanosheets to the sublimed sulfur is 0.3 g:0.7-1 g, and a heating reaction temperature is 150-160° C. with a reaction time of 8-10 h.
